(19) United States
(12) Patent Application Publication
(10) Pub. No.: US 2013/0033137 A1
(43) Pub. Date: Feb. 7, 2013

(54) Spindle motor

(71) Applicant: Chang Jo Yu, Suwon (KR)

(72) Inventor: Chang Jo Yu, Suwon (KR)

(73) Assignee: SAMSUNG ELECTRO-MECHANICS CO., LTD., Suwon (KR)

(21) Appl. No.: 13/317,361

(22) Filed: Oct. 17, 2011

(30) Foreign Application Priority Data
Aug. 2, 2011 (KR) 10-2011-0077009

(51) Int. Cl. H02K 7/08; F16C 32/06

(52) U.S. Cl. 310/90; 384/107; 384/113

(57) ABSTRACT

A spindle motor including: a lower thrust member fixedly coupled to a base member; a shaft fixedly coupled to at least one of the lower thrust member and the base member; a sleeve disposed on an upper portion of the lower thrust member and rotatably installed on the shaft; a rotor hub coupled to the sleeve to thereby rotate together with the sleeve; an upper thrust member fixedly coupled to an upper end portion of the shaft and forming a liquid-vapor interface together with the sleeve; and a cover member fixedly coupled to the shaft so as to be disposed on an upper portion of the upper thrust member, wherein the upper thrust member includes a stepped jaw part having a lower surface supported by an upper surface of the shaft and an upper surface pressed by the cover member, so as to increase coupling strength with the shaft.

### CROSS-REFERENCE TO RELATED APPLICATIONS

This application claims the priority of Korean Patent Application No. 10-2011-0077009 filed on Aug. 2, 2011, in the Korean Intellectual Property Office, the disclosure of which is incorporated herein by reference.

### BACKGROUND OF THE INVENTION

1. Field of the Invention

The present invention relates to a spindle motor, and more particularly, to a fixed shaft type spindle motor.

2. Description of the Related Art

A fixed shaft type spindle motor, in which a shaft having strong impact resistance is fixed to a case of a hard disk driving device, is generally mounted in an information recording and reproducing device such as a hard disk driving device for a server, or the like.

That is, the shaft is fixedly installed in the spindle motor mounted in the hard disk driving device for a server in order to prevent information stored in the server from being damaged and or being unrecordable/unreadable due to an external impact.

As described above, when the fixed type shaft is installed, two sleeves, two fixed members, two covers for shielding upper and lower portions of the fixed members, and the like, are generally required in order to configure a hydrodynamic bearing assembly filled with lubricating fluid. In other words, a large number of components are required in order to configure the hydrodynamic bearing assembly including the fixedly installed shaft. Since a large number of components are required in order to configure the hydrodynamic bearing assembly as described above, a manufacturing cost thereof increases.

In addition, recently, the development of a technique capable of improving rotational characteristics of a spindle motor including a fixed type shaft has been urgently demanded. To this end, the development of a structure for increasing a bearing span length has been urgently demanded.

### SUMMARY OF THE INVENTION

An aspect of the present invention provides a spindle motor having improved rotational characteristics. That is, an aspect of the present invention provides a spindle motor having improved rotational characteristics by increasing a bearing span length and at the same time, suppressing a deterioration in coupling strength between a shaft and a thrust member.

According to an aspect of the present invention, there is provided a spindle motor including: a lower thrust member fixedly coupled to a base member; a shaft fixedly coupled to at least one of the lower thrust member and the base member; a sleeve disposed on an upper portion of the lower thrust member and rotatably installed on the shaft; a rotor hub coupled to the sleeve to thereby rotate together with the sleeve; an upper thrust member fixedly coupled to an upper end portion of the shaft and forming a liquid-vapor interface together with the sleeve; and a cover member fixedly coupled to the shaft so as to be disposed on an upper portion of the upper thrust member, wherein the upper thrust member includes a stepped jaw part having a lower surface supported by an upper surface of the shaft and an upper surface pressed by the cover member, so as to increase coupling strength with the shaft.

The sleeve may have an inclination part formed in an upper end portion thereof so as to form the liquid-vapor interface together with the upper thrust member, the inclination part having an outer diameter larger in an upper portion thereof than in a lower portion thereof.

The upper thrust member may include a body having an inner surface bonded to the shaft, a protrusion part extended from the body to thereby form the liquid-vapor interface together with the inclination part, and the stepped jaw part extended in an inner radial direction from the inner surface of the body.

The shaft may include a depression groove formed to be depressed from an outer peripheral surface thereof so as to separate lubricating fluid filling a bearing clearance formed by the sleeve and the shaft into two parts.

The sleeve may include a communication hole disposed to face the depression groove to thereby provide communication between the depression groove and the outside of the sleeve.

The rotor hub may include: a rotor hub body including an insertion part formed therein, the insertion part including the upper thrust member insertedly disposed in an inner portion thereof; a mounting part extended from an edge of the rotor hub body and including a magnet assembly mounted on an inner surface thereof; and an extension part extended in an outer radial direction from an edge of the mounting part.

An outer surface of the upper thrust member and an inner surface of the rotor hub disposed to face the outer surface of the upper thrust member may have a clearance of 0.3 mm or less formed therebetween.

According to another aspect of the present invention, there is provided a spindle motor including: a lower thrust member fixedly coupled to a base member; a shaft fixedly coupled to on at least one of the lower thrust member and the base member; a sleeve disposed on an upper portion of the lower thrust member and rotatably installed on the shaft; a rotor hub coupled to the sleeve to thereby rotate together with the sleeve; an upper thrust member fixedly coupled to an upper end portion of the shaft and forming a liquid-vapor interface together with the sleeve; and a cover member fixedly coupled to the shaft so as to be disposed on an upper portion of the upper thrust member, wherein the shaft includes a step part formed in an upper end portion thereof, the step part supporting a lower surface of the upper thrust member so as to increase coupling strength with the upper thrust member.

The upper thrust member may have an upper surface disposed at a position higher than that of an upper surface of the shaft and pressed by the cover member.

According to another aspect of the present invention, there is provided a spindle motor including: a lower thrust member fixedly coupled to a base member; a shaft fixedly coupled to at least one of the lower thrust member and the base member; a sleeve disposed on an upper portion of the lower thrust member and rotatably installed on the shaft; a rotor hub coupled to the sleeve to thereby rotate together with the sleeve; an upper thrust member fixedly coupled to an upper end portion of the shaft and forming a liquid-vapor interface together with the sleeve; and a cover member fixedly coupled to the shaft so as to be disposed on an upper portion of the upper thrust member, wherein an upper surface of the shaft and an upper surface of the upper thrust member are coplanarly disposed and pressed by the cover member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a spindle motor according to an embodiment of the present invention;

FIG. 2 is an enlarged view of part A of FIG. 1;

FIG. 3 is a partially cut-away, exploded perspective view showing a sleeve and an upper thrust member according to an embodiment of the present invention;

FIG. 4 is a view describing an operation of the spindle motor according to an embodiment of the present invention;

FIG. 5 is a cross-sectional view schematically showing a spindle motor according to another embodiment of the present invention; and

FIG. 6 is a cross-sectional view schematically showing a spindle motor according to another embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

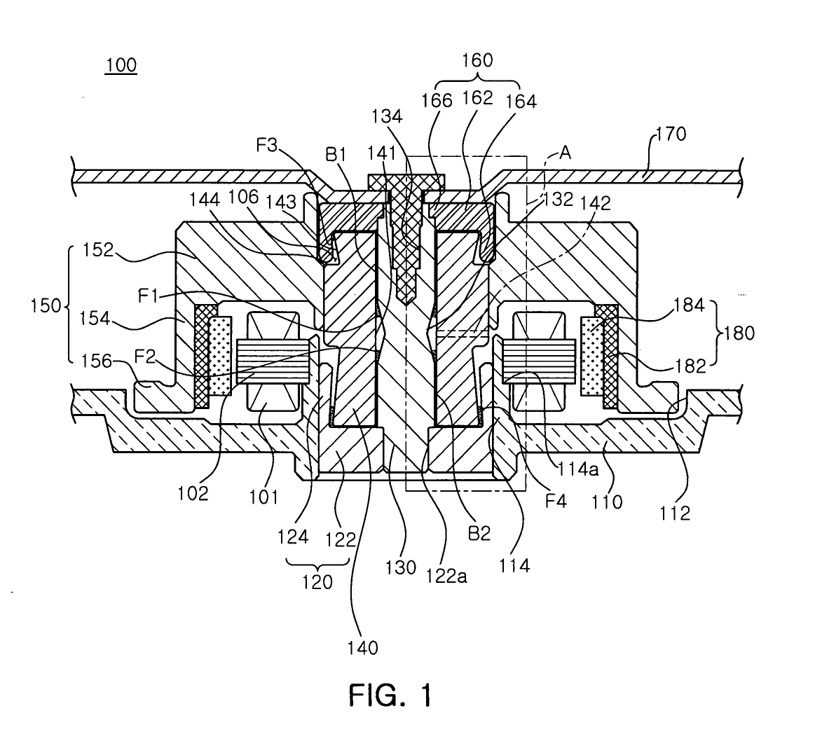

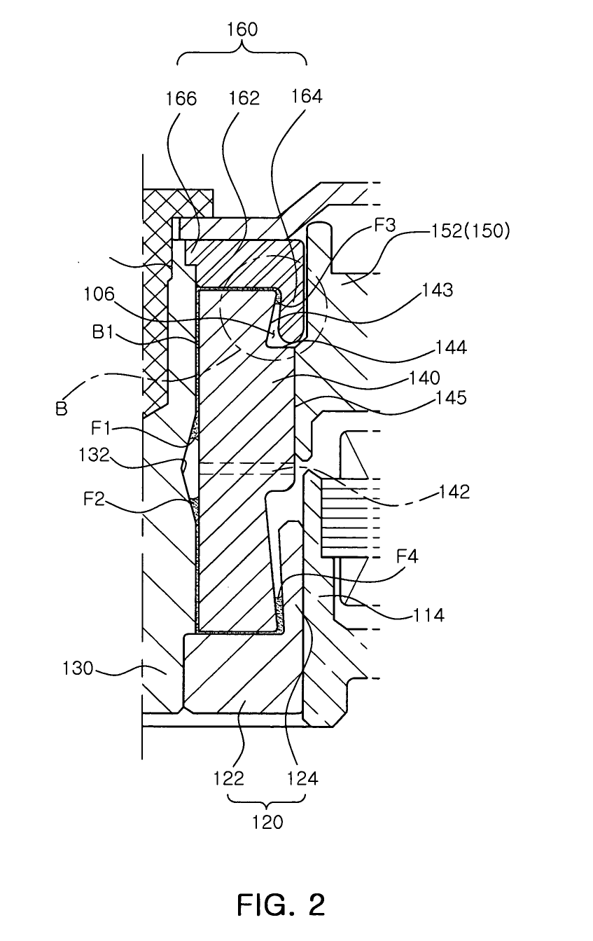

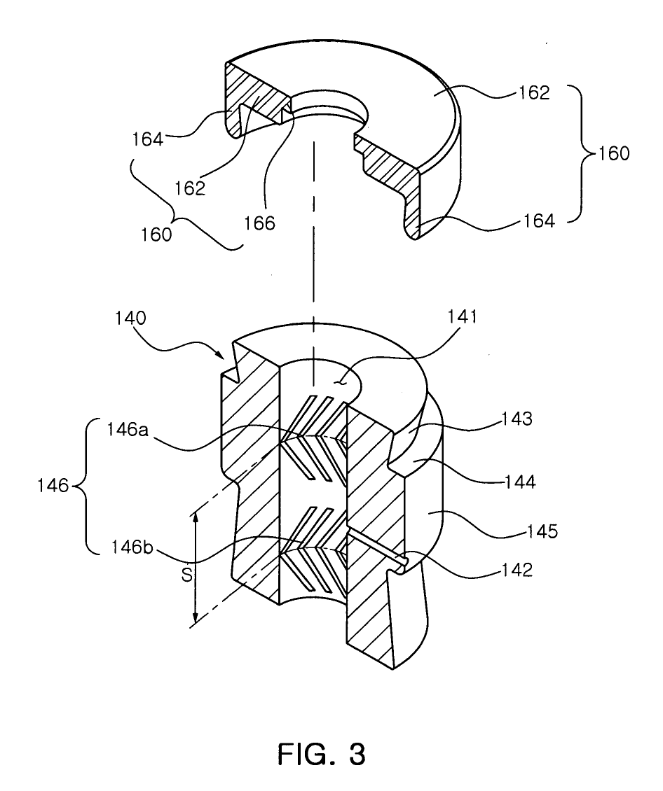

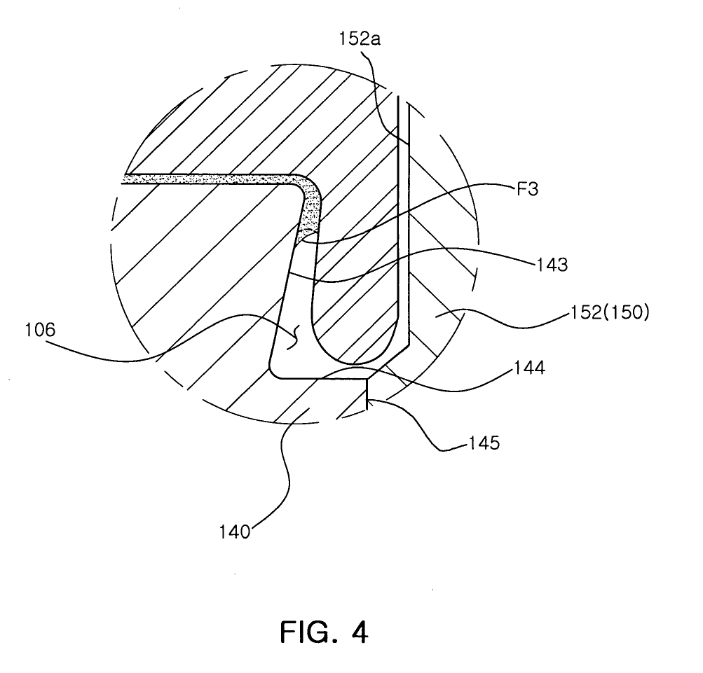

FIG. 1 is a cross-sectional view schematically showing a spindle motor according to an embodiment of the present invention. FIG. 2 is an enlarged view of part A of FIG. 1. FIG. 3 is a partially cut-away exploded perspective view showing a sleeve and an upper thrust member according to an embodiment of the present invention. FIG. 4 is a view describing an operation of the spindle motor according to an embodiment of the present invention.

Referring to FIGS. 1 through 4, a spindle motor 100 according to an embodiment of the present invention may include a base member 110, a lower thrust member 120, a shaft 130, a sleeve 140, a rotor hub 150, an upper thrust member 160, and a cover member 170.

The base member 110 may include a mounting groove 112 so as to form a predetermined space with regard to the rotor hub 150. In addition, the base member 110 may include a coupling part 114 extended upwardly in an axial direction and having a stator core 102 installed on an outer peripheral surface thereof.

In addition, the coupling part 114 may include a mounting surface 114a provided on the outer peripheral surface thereof in order that the stator core 102 may be mounted and installed thereon. Further, the stator core 102 mounted on the coupling part 114 may be disposed over the mounting groove 112 of the base member 110 described above.

The lower thrust member 120 is fixedly coupled to the base member 110. That is, the lower thrust member 120 is insertedly installed within the coupling part 114. More specifically, the lower thrust member 120 may be installed such that an outer peripheral surface thereof is bonded to an inner peripheral surface of the coupling part 114.

Meanwhile, the lower thrust member 120 may include a disk part 122 having an inner surface fixedly coupled to the shaft 130 and an outer surface fixedly coupled to the base member 110 and an extension part 124 extended upwardly from the disk part 122 in the axial direction.

That is, the lower thrust member 120 may have a cup shape having a hollow part. That is, the lower thrust member 120 may have an ‘L’-shaped cross section.

In addition, the disk part 122 may be provided with an installation hole 122a for installing the shaft 130, and the shaft 130 may be insertedly mounted in the installation hole 122a.

Here, terms with respect to directions will be defined. As viewed in FIG. 1, an axial direction refers to a vertical direction, that is, a direction from a lower portion of the shaft 130 toward an upper portion thereof or a direction from the upper portion of the shaft 130 toward the lower portion thereof, an inner radial direction or an outer radial direction refer to a horizontal direction, that is, a direction from the shaft 130 toward an outer peripheral surface of the rotor hub 150 or a direction from the outer peripheral surface of the rotor hub 150 toward shaft 130, and a circumferential direction refers to a rotation direction along the outer peripheral surface of the rotor hub 150.

In addition, the lower thrust member 120 is included, together with the base member 110, in a stationary member, that is, a stator.

Meanwhile, the outer surface of the lower thrust member 120 may be bonded to an inner surface of the base member 110 by an adhesive and/or welding. In other words, the outer surface of the lower thrust member 120 is fixedly bonded to an inner surface of the coupling part 114 of the base member 110.

In addition, a thrust dynamic pressure groove (not shown) for generating thrust fluid dynamic pressure may be formed in at least one of an upper surface of the lower thrust member 120 and a lower surface of the sleeve 140.

Further, the lower thrust member 120 may also serve as a sealing member for preventing lubricating fluid from being leaked.

The shaft 130 is fixedly coupled to at least one of the lower thrust member 120 and the base member 110. That is, the shaft 130 may be installed such that a lower end portion thereof is inserted into the installation hole 122a formed in the disk part 122 of the lower thrust member 120.

In addition, the lower end portion of the shaft 130 may be bonded to an inner surface of the disk part 122 by an adhesive and/or welding. Therefore, the shaft 130 may be fixed.

However, although the embodiment of the present invention describes a case in which the shaft 130 is fixedly coupled to the lower thrust member 120, the present invention is not limited thereto. That is, the shaft 130 may also be fixedly coupled to the base member 110.

Meanwhile, the shaft 130 is also included, together with the lower thrust member 120 and the base member 110, in the stationary member, that is, the stator.

In addition, the shaft 130 includes a depression groove 132 formed to be depressed from an outer peripheral surface thereof to thereby separate lubricating fluid filling bearing clearances B1 and B2 into two parts. The depression groove 132 may have a ‘V’ shaped cross section.

The depression groove 132 may serve to form a liquid-vapor interface (that is, an interface between the lubricating fluid and air) together with an inner surface of the sleeve 140.

A detailed description thereof will be provided below.

Meanwhile, the shaft 130 may include a coupling means 190, for example, a screw part 134 having a screw coupled thereto, formed in an upper surface thereof in order that a cover member 170 is fixedly coupled thereto.

The sleeve 140 may be rotatably installed on the shaft 130. To this end, the sleeve 140 may include a through hole 141 into which the shaft 130 is inserted. Meanwhile, in the case in which the sleeve 140 is installed on the shaft 130, an inner peripheral surface of the sleeve 140 and the outer peripheral surface of the shaft 130 are disposed to be spaced apart from each other by a predetermined interval to thereby form the bearing clearances B1 and B2 therebetween.

In addition, bearing clearances B1 and B2 are filled with lubricating fluid.

Here, describing the bearing clearances B1 and B2 in more detail, the bearing clearances B1 and B2 may include an upper bearing clearance B1 and a lower bearing clearance B2. In addition, the upper bearing clearance B1 refers to a space formed by an upper end portion of the shaft 130 and an upper end portion of the sleeve 140 and a space formed by the upper end portion of the sleeve 140 and the upper thrust member 160.

Further, the lower bearing clearance B2 refers to a space formed by the lower end portion of the shaft 130 and a lower end portion of the sleeve 140 and a space formed by the lower end portion of the sleeve 140 and the lower thrust member 120.

Meanwhile, here, describing the depression groove 132 formed in the shaft 130, the depression groove 132 may serve to form an interface between the lubricating fluid filling the respective bearing clearances B1 and B2, that is, the upper bearing clearance B1 and the lower bearing clearance B2, and air.

That is, an interface between the lubricating fluid filling the upper bearing clearance B1 and the air, a first liquid-vapor interface F1, may be formed at an upper portion of the depression groove 132. In addition, an interface between the lubricating fluid filling the lower bearing clearance B2 and the air, that is, a second liquid-vapor interface F2 may be formed at an lower portion of the depression groove 132.

The depression groove 132 may have a ‘V’ shape such that the first and second liquid-vapor interfaces F1 and F2 may be formed as described above. That is, the depression groove 132 may have the ‘V’ shape such that the first and second liquid-vapor interfaces F1 and F2 may be formed by a capillary phenomenon.

In addition, the sleeve 140 may include a communication hole 142 disposed to face the depression groove 132 to thereby provide communication between the depression groove 132 and the outside of the sleeve 140. That is, the communication hole 142 for allowing pressure in the depression groove 132 to be the same as that in the outside of the sleeve 140, may be formed in the sleeve 140, so as to form the first and second liquid-vapor interfaces F1 and F2 as described above.

Meanwhile, the sleeve 140 may have an inclination part 143 formed at the upper end portion thereof so as to form a liquid-vapor interface together with the upper thrust member 160, the inclination part 143 having an outer diameter larger in an upper portion thereof than in a lower portion thereof.

In other words, the inclination part 143 having an outer diameter larger in the upper portion thereof than in the lower portion thereof may be formed at the upper end portion of the sleeve 140, in such a manner that a third liquid-vapor interface F3 may be formed in a space between an outer peripheral surface of the sleeve 140 and an inner peripheral surface of the upper thrust member 160.

That is, the lubricating fluid filling the upper bearing clearance B1 may form the first and third liquid-vapor interfaces F1 and F3.

Meanwhile, the sleeve 140 may include a step surface 144 formed in the upper end portion thereof, the step surface 144 being formed to be stepped with respect to an upper surface of the sleeve 140 to thereby allowing for the formation of a sealing groove 106. A detailed description of the step surface 144 will be provided below.

In addition, the sleeve 140 includes the rotor hub 150 bonded to the outer peripheral surface thereof. That is, a lower portion of the step surface 144 may have a shape corresponding to that of an inner surface of the rotor hub 150, such that the rotor hub 150 may be fixedly coupled thereto. That is, the sleeve 140 may include a bonding surface 145 formed on the outer peripheral surface thereof.

Meanwhile, a lower end portion of the outer peripheral surface of the sleeve 140 may be inclined upwardly in the inner radial direction so as to form a liquid-vapor interface together with the extension part 124 of the lower thrust member 120.

That is, the lower end portion of the sleeve 140 may be inclined upwardly in the inner radial direction such that a fourth liquid-vapor interface F4 may be formed in a space between the outer peripheral surface of the sleeve 140 and the extension part 124 of the lower thrust member 120.

As described above, since the fourth liquid-vapor interface F4 is formed in the space between the lower end portion of the sleeve 140 and the extension part 124, the lubricating fluid filling the lower bearing clearance B2 may form the second and fourth liquid-vapor interfaces F2 and F4.

In addition, the sleeve 140 may include a dynamic pressure groove 146 formed in the inner surface thereof, the dynamic pressure groove 146 generating fluid dynamic pressure through the lubricating fluid filling the bearing clearances B1 and B2 at the time of rotation of the sleeve 140. That is, the dynamic pressure groove 146 may include upper and lower dynamic grooves 146a and 146b, as shown in FIG. 3.

However, the dynamic pressure groove 146 is not limited to being formed in the inner surface of the sleeve 140 but may also be formed in the outer peripheral surface of the shaft 130.

The rotor hub 150 is coupled to the sleeve 140 to thereby rotate together with the sleeve 140.

The rotor hub 150 may include a rotor hub body 152 including an insertion part 152a formed therein, the insertion part 152a including the upper thrust member 160 insertedly disposed in an inner portion thereof, a mounting part 154 extended from an edge of the rotor hub body 152 and including a magnet assembly 180 mounted on an inner surface thereof, and an extension part 156 extended in the outer raidal direction from an edge of the mounting part 154.

Meanwhile, a lower end portion of an inner surface of the rotor hub body 152 may be bonded to an outer surface of the sleeve 140. That is, the lower end portion of the inner surface of the rotor hub body 152 may be bonded to the bonding surface 145 of the sleeve 140 by an adhesive and/or welding.

Therefore, the sleeve 140 may rotate together with the rotor hub 150 at the time of rotation of the rotor hub 150.

In addition, the mounting part 154 is extended downwardly from the rotor hub body 152 in the axial direction. Further, the mounting part 154 may include the magnet assembly 180 fixedly coupled to the inner surface thereof.

Meanwhile, the magnet assembly 180 may include a yoke 182 fixedly coupled to the inner surface of the mounting part 154 and a magnet 184 installed on an inner peripheral surface of the yoke 182.

The yoke 182 may serve to direct a magnetic field from the magnet 184 toward the stator core 102 to thereby increase magnetic flux density. Meanwhile, the yoke 182 may have a circular ring shape or have a shape in which one end portion thereof is bent so as to increase the magnetic flux density due to the magnetic field generated from the magnet 184.

The magnet 184 may have an annular ring shape and may be a permanent magnet generating a magnetic field having a predetermined strength by alternately magnetizing an N pole and an S pole in the circumferential direction.

Meanwhile, the magnet 184 is disposed to face a front end of the stator core 102 having a coil 101 wound therearound and generates driving force by electromagnetic interaction with the stator core 102 having the coil 101 wound therearound so that the rotor hub 150 may rotate.

That is, when power is supplied to the coil 101, the driving force rotating the rotor hub 150 is generated by the electromagnetic interaction between the stator core 102 having the coil 101 wound theraround and the magnet 184 disposed to face the stator core 102, such that the rotor hub 150 may rotate together with the sleeve 140.

The upper thrust member 160 is fixedly coupled to the upper end portion of the shaft 130 and forms the liquid-vapor interface together with the sleeve 140. In addition, the upper thrust member 160 may include a stepped jaw part 166 having a lower surface supported by the upper surface of the shaft 130 and an upper surface pressed by the cover member 170, so as to increase coupling strength with the shaft 130.

Meanwhile, the upper thrust member 160 may include a body 162 having an inner surface bonded to the shaft 130, a protrusion part 164 extended from the body 162 to thereby form the liquid-vapor interface together with the inclination part 143, and the stepped jaw part 166 extended in the inner radial direction from the inner surface of the body 162.

The protrusion part 164 may be extended downwardly from the body 162 in the axial direction and have an inner surface disposed to face the inclination part 143.

In addition, the protrusion part 164 may be extended from the body 162 so as to be in parallel with the shaft 130.

Further, the upper thrust member 160 may be insertedly disposed in a space formed by the upper end portion of the outer peripheral surface of the shaft 130, the outer surface of the sleeve 140, and the inner surface of the rotor hub 150.

In addition, the upper thrust member 160, which is also a stationary member fixedly installed, together with the base member 110, the lower thrust member 120, and the shaft 130, may be a member configuring the stator.

Meanwhile, since the upper thrust member 160 is fixedly installed on the shaft 130 and the sleeve 140 rotates together with the rotor hub 150, the third liquid-vapor interface F3 formed in the space between the inclination part 143 of the sleeve 140 and the protrusion part 164 is inclined toward the inclination part 143 of the sleeve 140 at the time of the rotation of the sleeve 140, as shown in FIG. 4.

That is, the third liquid-vapor interface F3 is inclined toward the outer peripheral surface of the sleeve 140, whereby scattering of the lubricating fluid due to centrifugal force may be further reduced.

In addition, an outer peripheral surface of the upper thrust member 160 and the inner surface of the rotor hub 150 disposed to face the outer peripheral surface of the upper thrust member 160 may form a labyrinth seal. That is, an outer surface of the upper thrust member 160 and the inner surface of the rotor hub body 152 may be disposed to be spaced apart from each other by a predetermined interval and form the labyrinth seal so as to restrain air containing evaporated lubricating fluid from flowing to the outside.

Therefore, the flowing of air containing the evaporated lubricating fluid to the outside is restrained, whereby a reduction in the amount of lubricating fluid may be suppressed.

In addition, the outer peripheral surface of the upper thrust member 160 and the inner surface of the rotor hub body 152 may have a clearance of 0.3 mm or less therebetween.

Further, the stepped jaw part 166 is pressed by the cover member 170 when the cover member 170 is fixedly coupled to the shaft 130 by the coupling means 190, that is, a screw. Therefore, coupling strength between the upper thrust member 160 and the shaft 130 may be increased.

That is, the stepped jaw part 166 has the lower surface thereof supported by the shaft 130 and the upper surface thereof pressed by the cover member 170 to thereby more firmly fix the upper thrust member 160 to the shaft 130.

Therefore, in contrast with a case in which a thickness of the upper thrust member 160 is not reduced, even in the case that a thickness of the body 162 of the upper thrust member 160 is reduced, the upper thrust member 160 and the shaft 130 may maintain a predetermined coupling strength therebetween.

As a result, due to the stepped jaw part 166, an axial length of the sleeve 140 may be increased while the thickness of the upper thrust member 160 is reduced. In this case, a bearing span length S may be increased.

That is, the bearing span length S is increased, whereby rotational characteristics of the sleeve 140 and the rotor hub 150 may be improved.

Meanwhile, a thrust dynamic pressure groove (not shown) for generating thrust dynamic pressure may be formed in at least one of the lower surface of the upper thrust member 160 and the upper surface of the sleeve 140 disposed to face the lower surface of the upper thrust member 160.

In addition, the upper thrust member 160 may also serve as a sealing member preventing the lubricating fluid filling the upper bearing clearance B1 from being leaked upwardly.

Further, the upper thrust member 160 may have a thickness such that an upper surface thereof may be coplanarly disposed with the upper surface of the shaft 130 when the upper thrust member 160 is installed on the shaft 130.

The cover member 170 may be fixedly coupled to the shaft 130 so as to be disposed over the upper thrust member 160. The cover member 170 may be fixedly coupled to the shaft 130 by the coupling unit 190, for example, a screw.

In addition, the cover member 170 is installed on the shaft 130 such that a lower surface thereof may presse the upper surface of the upper thrust member 160. Therefore, the cover member 170 may serve to prevent the upper thrust member 160 from being separated from the shaft 130 at the time of occurrence of an external impact.

As described above, the coupling strength between the upper thrust member 160 and the shaft 130 may be increased by the stepped jaw part 166. Therefore, the thickness of the upper thrust member 160 may be reduced.

Accordingly, the axial length of the sleeve 140 is increased with the reduction in the thickness of the upper thrust member 160, to thereby allow for an increase in the bearing span length S, whereby the rotational characteristics of the sleeve 140 and the rotor hub 150 may be improved.

In addition, the upper thrust member 160 and the rotor hub 150 have a small clearance therebetween to restain air containing the evaporated lubricating fluid from flowing to the outside, whereby a reduction in the amount of lubricating fluid filling the upper bearing clearance B1 may be suppressed.

In addition, the spindle motor 100 according to the embodiment of the present invention may need not to include a separate sealing member for preventing leakage of the lubricating fluid, such that the bearing span length S may further be increased to thereby allow for improvements in rotational characteristics.

Here, the bearing span length S refers to a distance between an area in which maximum dynamic pressure is generated when the lubricating fluid is pumped by an upper dynamic pressure groove 124a and an area in which maximum dynamic pressure is generated when the lubricating fluid is pumped by a lower dynamic pressure groove 124b.

That is, the spindle motor 100 according to the embodiment of the present invention may need not to include a separate sealing member to allow for a reduction in a portion at which the separate sealing member is installed, whereby a length of the sleeve 140 may be increased. Therefore, the bearing span length S may also be increased.

In addition, since the spindle motor 100 according to the embodiment of the present invention may need not to include a separate sealing member, manufacturing costs thereof may be reduced and manufacturing yield thereof may be improved.

Meanwhile, the sleeve 140, a rotating member forming the liquid-vapor interfaces, that is, the third and fourth liquid-vapor interfaces F3 and F4, together with stationary members (upper and lower thrust members), may be disposed in the inner radial direction with respect to the stationary members, whereby scattering of the lubricating fluid due to centrifugal force may be reduced.

Hereinafter, a spindle motor according to another embodiment of the present invention will be described with reference to the accompanying drawings. However, a detailed description of components the same as those discussed above will be omitted and be replaced by the above-mentioned description.

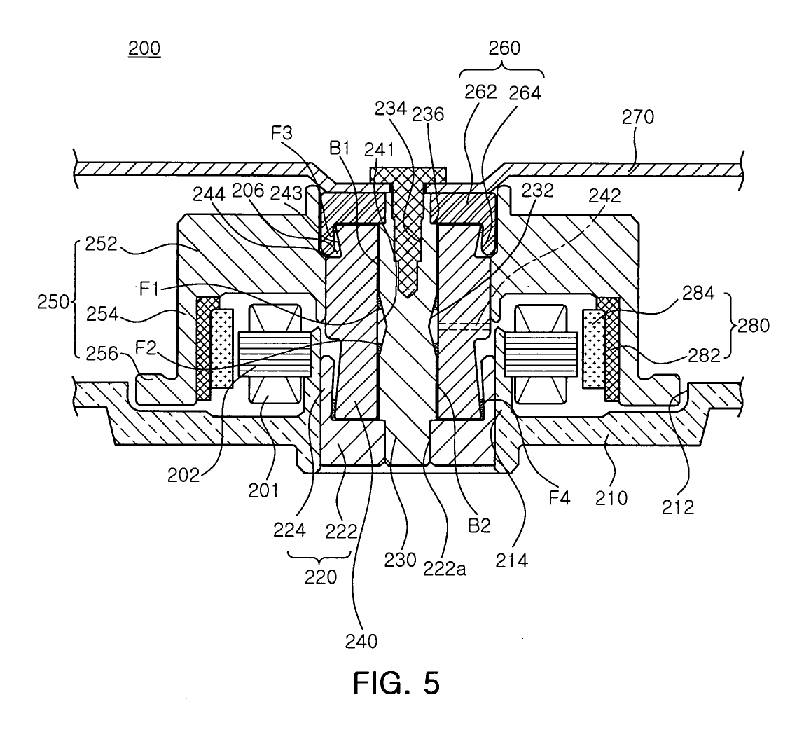

FIG. 5 is a cross-sectional view schematically showing a spindle motor according to another embodiment of the present invention.

Referring to FIG. 5, a spindle motor 200 according to another embodiment of the present invention may include a base member 210, a lower thrust member 220, a shaft 230, a sleeve 240, a rotor hub 250, an upper thrust member 260, and a cover member 270.

Meanwhile, the base member 210, the lower thrust member 220, the sleeve 240, the rotor hub 250, and the cover member 270 have the same configurations as those of the base member 110, the lower thrust member 120, the sleeve 140, the rotor hub 150, and the cover member 170 included in the spindle motor 100 according to the foregoing embodiment of the present invention described above. Therefore, a detailed description thereof will be omitted and be replaced by the above-mentioned description.

In addition, the shaft 230 is also the same as the shaft 130 included in the spindle motor 100 according to the foregoing embodiment of the present invention, except for a step part 236 to be described below. Further, the upper thrust member 260 is different only in terms of a shape from the upper thrust member 160 included in the spindle motor 100 according to the foregoing embodiment of the present invention described above and has the same configuration as the upper thrust member 160.

Hereinafter, only the step part 236 and a shape of the upper thrust member 260 will be described.

The shaft 230 may include the step part 236 formed in an upper end portion thereof, the step part 236 supporting a lower surface of the upper thrust member 260 so as to increase coupling strength with the upper thrust member 260.

Therefore, a contact area between the upper thrust member 260 and the shaft 230 is increased, whereby the coupling strength between the upper thrust member 260 and the shaft 230 may be increased. In addition, when the cover member 270 is installed on the shaft 230, the lower surface of the upper thrust member 260 may be supported by the step part 236 of the shaft 230 and an upper surface thereof may be pressed by the cover member 270.

Therefore, the coupling strength between the upper thrust member 260 and the shaft 230 may be further increased.

Meanwhile, the upper thrust member 260 is fixedly coupled to the upper end portion of the shaft 230 and forms a liquid-vapor interface together with the sleeve 240.

In addition, the upper thrust member 260 may include a body 262 having an inner surface bonded to the shaft 230 and a protrusion part 264 extended from the body 262 to thereby form the liquid-vapor interface together with an inclination part 243.

The protrusion part 264 may be extended downwardly from the body 262 in the axial direction and have an inner surface disposed to face the inclination part 243.

In addition, the protrusion part 264 may be extended from the body 262 so as to be in parallel with with the shaft 230.

Further, the upper thrust member 260 may be insertedly disposed in a space formed by an upper end portion of an outer peripheral surface of the shaft 230, an outer surface of the sleeve 240, and an inner surface of the rotor hub 250.

Meanwhile, the upper thrust member 260 may be installed on the shaft 230 in such a manner that the upper surface thereof is disposed at a position higher than that of an upper surface of the shaft 230. Therefore, only an inner diameter part of the upper thrust member 260 may be pressed by the cover member 270 at the time of the installation of the cover member 270.

As a result, pressing force of the cover member 270 is increased, whereby coupling strength between the upper thrust member 260 and the shaft 230 may be further increased.

As described above, the upper thrust member 260 is coupled to the shaft 230 while being mounted on the step part 236 of the shaft 230, whereby the coupling strength between the upper thrust member 260 and the shaft 230 may be further increased.

Meanwhile, the spindle motor 200 according to another embodiment of the present invention may also realize effects the same as those implemented by the spindle motor 100 according to the foregoing embodiment of the present invention. The detailed description thereof will be omitted.

Hereinafter, a spindle motor according to another embodiment of the present invention will be described with reference to the accompanying drawings. However, a detailed description of the same components as the above-mentioned components will be omitted and be replaced by the above-mentioned description.

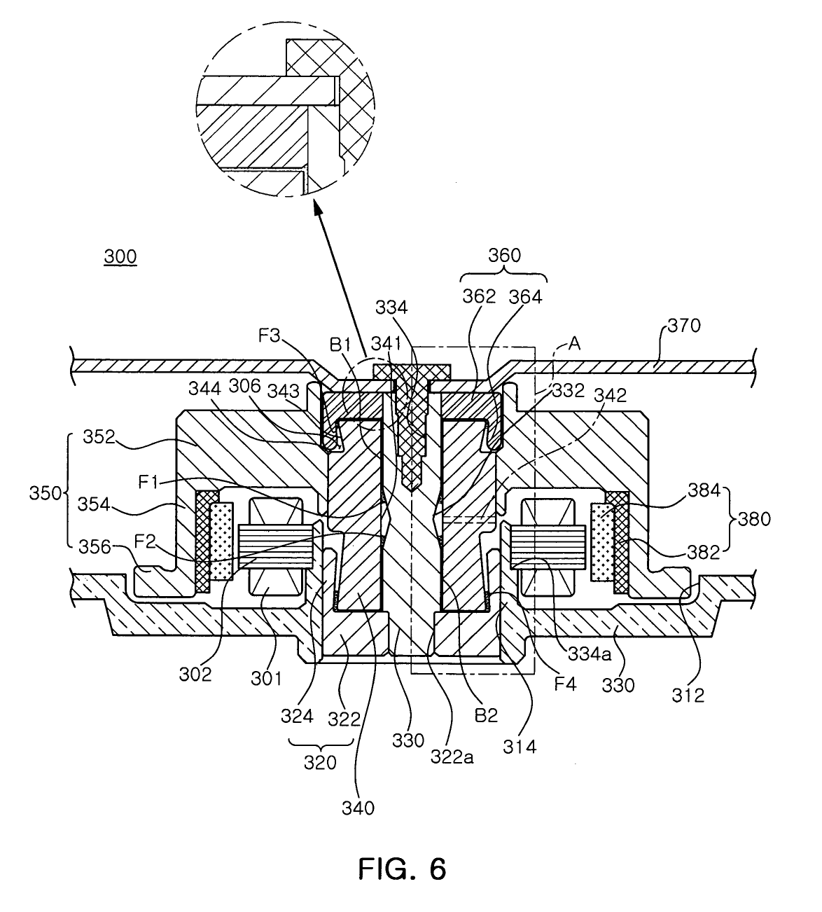

FIG. 6 is a cross-sectional view schematically showing a spindle motor according to another embodiment of the present invention.

Referring to FIG. 6, a spindle motor 300 according to another embodiment of the present invention may include a base member 310, a lower thrust member 320, a shaft 330, a sleeve 340, a rotor hub 350, an upper thrust member 360, and a cover member 370.

Meanwhile, the base member 310, the lower thrust member 320, the shaft 330, the sleeve 340, the rotor hub 350, and the cover member 370 have the same configurations as those of the base member 110, the lower thrust member 120, the shaft 130, the sleeve 140, the rotor hub 150, and the cover member 170 included in the spindle motor 100 according to the foregoing embodiment of the present invention described above. Therefore, a detailed description thereof will be omitted and be replaced by the above-mentioned description.

Further, the upper thrust member 360 is different only in terms of a shape from the upper thrust member 160 included in the spindle motor 100 according to the foregoing embodiment of the present invention described above and has the same configuration as the upper thrust member 160.

Hereinafter, only a shape of the upper thrust member 360 will be described.

An upper surface of the shaft 330 and an upper surface of the upper thrust member 360 may be coplanarly disposed and be pressed by the cover member 370.

That is, the upper thrust member 360 may have a thickness such that the upper surface thereof may be coplanarly disposed with the upper surface of the shaft 330. Therefore, both upper surfaces of the upper thrust member 360 and the shaft 330 may be pressed by the cover member 370 at the time of the installation of the cover member 370.

As set forth above, according to the embodiments of the present invention, coupling strength between the shaft and the upper thrust member could be increased by the stepped jaw part included in the upper thrust member, whereby a thickness of the upper thrust member may be reduced.

Therefore, a bearing span length is increased with a reduction in the thickness of the upper thrust member, whereby rotational characteristics may be improved.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a lower thrust member fixedly coupled to a base member;
a shaft fixedly coupled to at least one of the lower thrust member and the base member;
a sleeve disposed on an upper portion of the lower thrust member and rotatably installed on the shaft;
a rotor hub coupled to the sleeve to thereby rotate together with the sleeve;
an upper thrust member fixedly coupled to an upper end portion of the shaft and forming a liquid-vapor interface together with the sleeve; and
a cover member fixedly coupled to the shaft so as to be disposed on an upper portion of the upper thrust member,
wherein the upper thrust member includes a stepped jaw part having a lower surface supported by an upper surface of the shaft and an upper surface pressed by the cover member, so as to increase coupling strength with the shaft.

2. The spindle motor of claim 1, wherein the sleeve has an inclination part formed in an upper end portion thereof so as to form the liquid-vapor interface together with the upper thrust member, the inclination part having an outer diameter larger in an upper portion thereof than in a lower portion thereof.

3. The spindle motor of claim 2, wherein the upper thrust member includes a body having an inner surface bonded to the shaft, a protrusion part extended from the body to thereby form the liquid-vapor interface together with the inclination part, and the stepped jaw part extended in an inner radial direction from the inner surface of the body.

4. The spindle motor of claim 3, wherein the shaft includes a depression groove formed to be depressed from an outer peripheral surface thereof so as to separate lubricating fluid filling a bearing clearance formed by the sleeve and the shaft into two parts.

5. The spindle motor of claim 4, wherein the sleeve includes a communication hole disposed to face the depression groove to thereby provide communication between the depression groove and the outside of the sleeve.

6. The spindle motor of claim 1, wherein the rotor hub includes:
a rotor hub body including an insertion part formed therein, the insertion part including the upper thrust member insertedly disposed in an inner portion thereof;
a mounting part extended from an edge of the rotor hub body and including a magnet assembly mounted on an inner surface thereof; and
an extension part extended in an outer radial direction from an edge of the mounting part.

7. The spindle motor of claim 1, wherein an outer surface of the upper thrust member and an inner surface of the rotor hub disposed to face the outer surface of the upper thrust member have a clearance of 0.3 mm or less formed therebetween.

8. A spindle motor comprising:
a lower thrust member fixedly coupled to a base member;
a shaft fixedly coupled to on at least one of the lower thrust member and the base member;
a sleeve disposed on an upper portion of the lower thrust member and rotatably installed on the shaft;
a rotor hub coupled to the sleeve to thereby rotate together with the sleeve;
an upper thrust member fixedly coupled to an upper end portion of the shaft and forming a liquid-vapor interface together with the sleeve; and
a cover member fixedly coupled to the shaft so as to be disposed on an upper portion of the upper thrust member,
wherein the shaft includes a step part formed in an upper end portion thereof, the step part supporting a lower surface of the upper thrust member so as to increase coupling strength with the upper thrust member.

9. The spindle motor of claim 8, wherein the upper thrust member has an upper surface disposed at a position higher than that of an upper surface of the shaft and pressed by the cover member.

10. A spindle motor comprising:
a lower thrust member fixedly coupled to a base member;
a shaft fixedly coupled to at least one of the lower thrust member and the base member;
a sleeve disposed on an upper portion of the lower thrust member and rotatably installed on the shaft;
a rotor hub coupled to the sleeve to thereby rotate together with the sleeve;
an upper thrust member fixedly coupled to an upper end portion of the shaft and forming a liquid-vapor interface together with the sleeve; and
a cover member fixedly coupled to the shaft so as to be disposed on an upper portion of the upper thrust member,
wherein an upper surface of the shaft and an upper surface of the upper thrust member are coplanarly disposed and pressed by the cover member.
